(19) United States
(12) Patent Application Publication
(10) Pub. No.: US 2012/0113070 A1
(43) Pub. Date: May 10, 2012

(54) GATE DRIVER CIRCUIT AND ARRANGEMENT METHOD OF THE SAME

(75) Inventors: Hsiao-Wen WANG, Hsin-Chu (TW); Chung-Chun CHEN, Hsin-Chu (TW); Jui-Chi LO, Hsin-Chu (TW); Chun-Hung KUO, Hsin-Chu (TW)

(73) Assignee: AU OPTRONICS CORP., HSINCHU (TW)

(21) Appl. No.: 13/273,296

(22) Filed: Oct. 14, 2011

(30) Foreign Application Priority Data
Nov. 8, 2010 (TW) 099138371

(51) Int. Cl. G09G 5/00

(52) U.S. Cl. 345/204

(57) ABSTRACT

An arrangement method, applied to a plurality of gate driver modules coupled in series and arranged on two sides of a panel, includes steps of: placing a first gate driver module on a first side of the panel; placing a gate driver set on a second side of the panel; and placing a fourth gate driver module on the first side of the panel. The gate driver set includes a second gate driver module and a third gate driver module serially connected. The output terminal of the first gate driver module is electrically coupled to the second gate driver module and the output terminal of the third gate driver module is electrically coupled to the fourth gate driver module. A gate driver circuit and an arrangement method applied to a plurality of shift register sets coupled in series and arranged on two sides of a panel are also disclosed.

### TECHNICAL FIELD

The disclosure relates to a gate driver circuit of a display panel, and more particularly to a gate driver circuit having multiple gate driver modules placed on two sides of the display panel and an arrangement method of the same.

### BACKGROUND

FIG. 1 is a diagram that schematically depicts a structure of a display panel. As depicted in FIG. 1, the display panel structure 10 mainly includes a pixel array 12 and a gate driver circuit 14 arranged near one side of the pixel array 12. The gate driver circuit 14 includes N gate driver modules 16, and each gate driver module 16 controls one of N gate lines (not shown) of the pixel array 12. The N gate driver modules 16 are coupled in series to sequentially transmit driving signals. Moreover, each gate driver module 16 is mainly implemented by a shift register (SR) 18.

As depicted in FIG. 1, the gate driver module 16 has length of Y and width of X, accordingly, the gate driver modules 16 has an area size of XY (X*Y). Because the N gate driver modules 16 are arranged on a same side of the pixel array 12, the border of the display panel 10 is restrict to a width of Z which is necessary to be larger than the width X of the gate driver module 16, so that the border of the display panel 10 cannot be adjusted flexibly according to actual needs.

To get a slim border, the art known by inventor is disclosed in FIG. 2A, which is a diagram that schematically depicts a display panel having a structure of placing multiple gate driver modules evenly on both sides of a pixel array. As depicted in FIG. 2A, the display panel 20 mainly includes a pixel array 22, a first gate driver circuit 24 and a second gate circuit driver 26. The first gate driver circuit 24 is arranged on the outside of the first side of the pixel array 22 and the second gate driver circuit 26 is arranged on the outside of the second side (corresponding to the first side) of the pixel array 22. The N gate driver modules 28 of the display panel 20 are evenly allocated to the first gate driver circuit 24 and the second gate driver circuit 26. As depicted in FIG. 2A, because the N gate driver modules 28 are evenly arranged on the first and second sides of the pixel array 22, the length of the gate driver module 28 can be designed up to 2Y and the width of the gate driver module 28 can be designed down to X/2, wherein the area size of the gate driver module 28 is still XY ((X/2)*(2Y)). Because the unit width of the gate driver module 28 is decreased to X/2, accordingly, the border width of the display panel 20 can be flexibly adjust to Z which is larger than the unit width X/2 of the gate driver module 28, thereby the display panel 20 with a slim border is realized.

FIG. 2B is a diagram that schematically depicts the driving signal sequentially transmitted in the N gate driver modules coupled in series in the display panel. As depicted in FIG. 2B, the first gate driver module 31 and the third gate driver module 33 are arranged in the first gate driver circuit 24; and the second gate driver module 32 and the fourth gate driver module 34 are arranged in the second gate driver circuit 26. Moreover, the output terminal (not shown) of the first gate driver module 31 is electrically coupled to the second gate driver module 32; the output terminal of the second gate driver module 32 is electrically coupled to the third gate driver module 33; and the output terminal of the third gate driver module 33 is electrically coupled to the fourth gate driver module 34. As depicted in FIG. 2B, the driving signal is transmitted to the fourth gate driver module 34 from the first gate driver module 31 sequentially via the second gate driver module 32 and the third gate driver module 33.

The disclosure discloses a display panel having another structure of placing multiple gate driver modules on both sides of the pixel array. The disclosure also discloses an arrangement method of the same.

### SUMMARY

An embodiment provides an arrangement method applied to a plurality of gate driver modules coupled in series and arranged on two sides of a panel. The arrangement method comprises steps of: placing a first gate driver module on a first side of the panel; placing a gate driver set on a second side of the panel; and placing a fourth gate driver module on the first side of the panel. The gate driver set comprises a second gate driver module and a third gate driver module serially connected. The output terminal of the first gate driver module is electrically coupled to the second gate driver module and the output terminal of the third gate driver module is electrically coupled to the fourth gate driver module.

Another embodiment provides a gate driver circuit of a panel. The gate driver circuit comprises a first gate driver module, a first gate driver module set and a fourth gate driver module. The first gate driver module is arranged on a first side of the panel for outputting a driving signal. The first gate driver module set is arranged on a second side of the panel and electrically coupled to the first gate driver module. The first gate driver module set comprises a plurality of gate driver modules coupled in series. The fourth gate driver module is arranged on the first side of the panel and electrically coupled to the first gate driver module set for receiving the driving signal from the first gate driver module set and then further transmitting the driving signal.

In one embodiment, a second gate driver module is the first one gate driver module and a third gate driver module is the last one gate driver module in the first gate driver module set. The second gate driver module is electrically coupled to the first gate driver module for receiving the driving signal from the first gate driver module. The third gate driver module is electrically coupled to the fourth gate driver module for transmitting the driving signal to the fourth gate driver module.

In one embodiment, the above mentioned gate driver circuit further comprises a first buffer unit. The first buffer unit is arranged on the first side of the panel and electrically coupled between the first gate driver module and the second gate driver module and for receiving and storing the driving signal from the first gate driver module and then further transmitting the driving signal to the second gate driver module.

In one embodiment, the above mentioned gate driver circuit further comprises a second buffer unit. The second buffer unit is arranged on the second side of the panel and electrically coupled between the third gate driver module and the fourth gate driver module and for receiving and storing the driving signal from the third gate driver module and then further transmitting the driving signal to the fourth gate driver module.

In one embodiment, the above mentioned gate driver circuit further comprises a second gate driver module set. The second gate driver module set is arranged on the first side of the panel and electrically coupled to the first gate driver module set. The second gate driver module set comprises a plurality of gate driver modules coupled in series and the first gate driver module is the last one gate driver module in the second gate driver module set.

In one embodiment, the above mentioned gate driver circuit further comprises a third gate driver module set. The third gate driver module set is arranged on the first side of the panel and electrically coupled to the first gate driver module set. The third gate driver module set comprises a plurality of gate driver modules coupled in series and the fourth gate driver module is the first one gate driver module in the third gate driver module set.

Another embodiment provides an arrangement method applied to a plurality of shift register sets coupled in series and arranged on two sides of a panel. The arrangement method comprises steps of: placing a first shift register set and a second shift register set on a first side of the panel; and placing a third shift register set on a second side of the panel. Each of the first, the second, and the third shift register set comprises a plurality of shift registers. The shift registers in the first shift register set are coupled in series. The shift registers in the second shift register set are coupled in series. The shift registers in the third shift register set are coupled in series. The output terminal of the last shift register in the first shift register set is electrically coupled to the first shift register in the third shift register set. The output terminal of the last shift register in the third shift register set is electrically coupled to the first shift register in the second shift register set.

By introducing the panel structure disclosed in the present disclosure, a plurality of gate drivers modules are arranged on both sides of a pixel array thereby the panel has a thin border.

### BRIEF DESCRIPTION OF THE DRAWINGS

The above objects and advantages of the disclosure become more readily apparent to those ordinarily skilled in the art after reviewing the following detailed description and accompanying drawings, in which:

FIG. 1 is a diagram that schematically depicts a structure of a display panel;

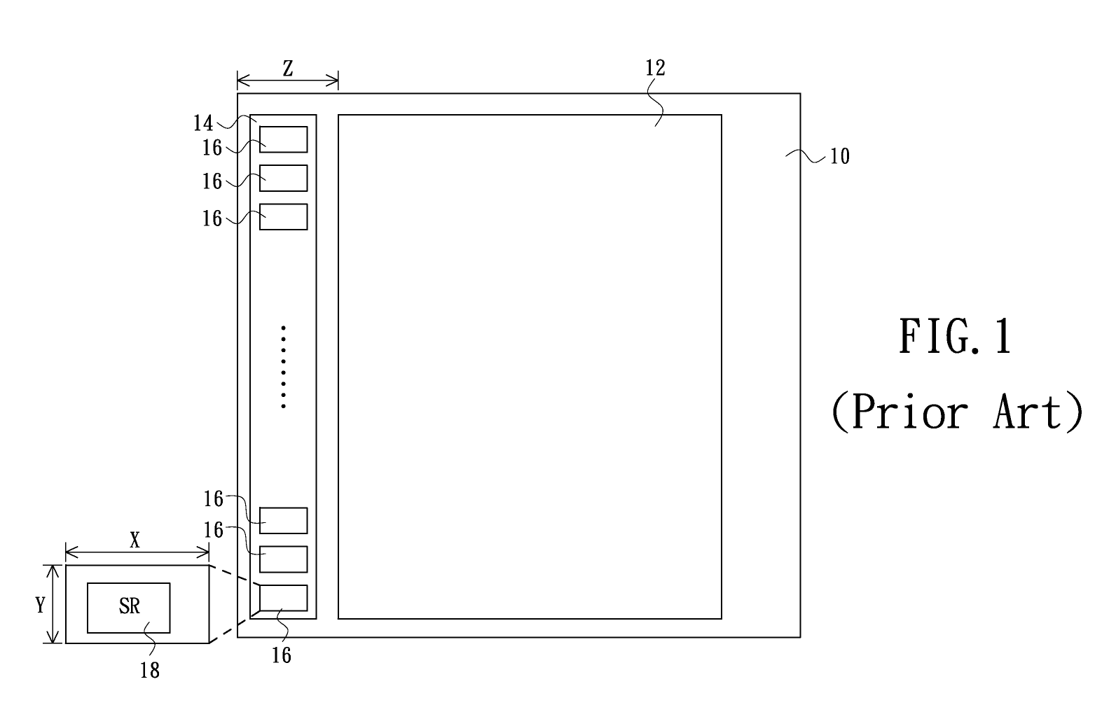

FIG. 2A is a diagram that schematically depicts a display panel having a structure of placing multiple gate driver modules on both sides of a pixel array;

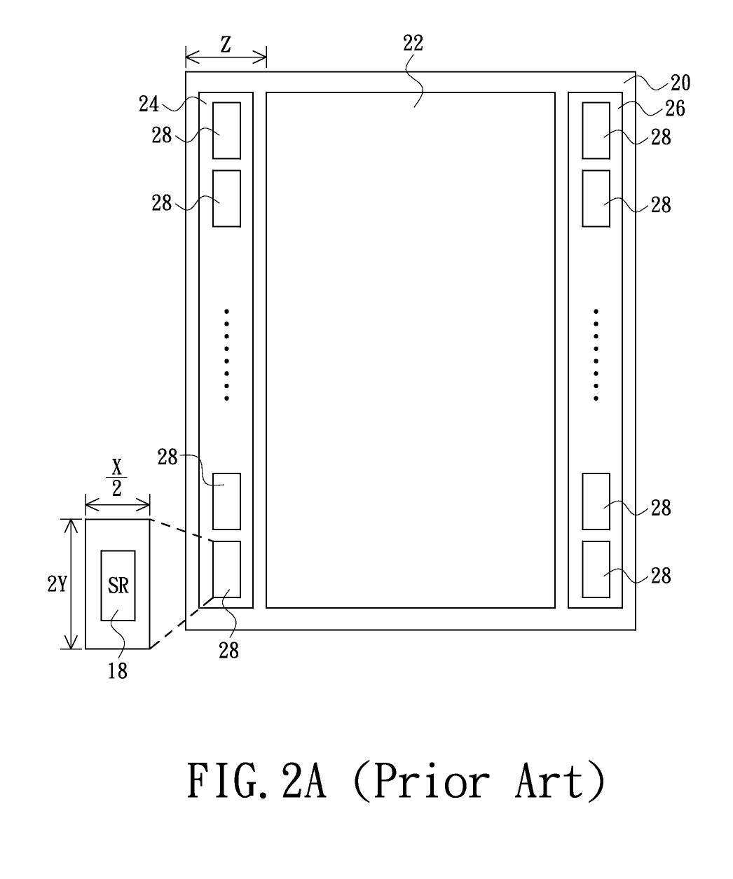

FIG. 2B is a diagram that schematically depicts the driving signal sequentially transmitted in the N gate driver modules coupled in series in the display panel structure;

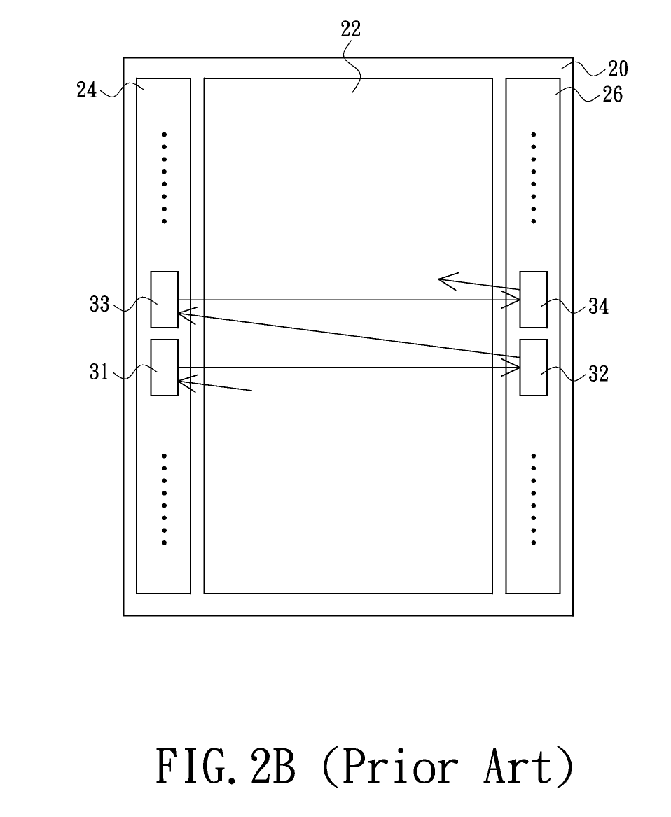

FIG. 3A is a diagram that schematically depicts a driving signal sequentially transmitted in N gate driver modules coupled in series in a display panel structure;

FIG. 3B is a diagram that schematically depicts a driving signal sequentially transmitted in N gate driver modules coupled in series in a display panel structure;

FIG. 4A is a diagram that schematically depicts the driving signal sequentially transmitted in the N gate driver modules coupled in series in the display panel structure disclosed in one embodiment; and

FIG. 4B is a circuit diagram that schematically depicts the display panel structure disclosed in one embodiment having an arrangement of placing the N gate driver modules on the two sides of the pixel array.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

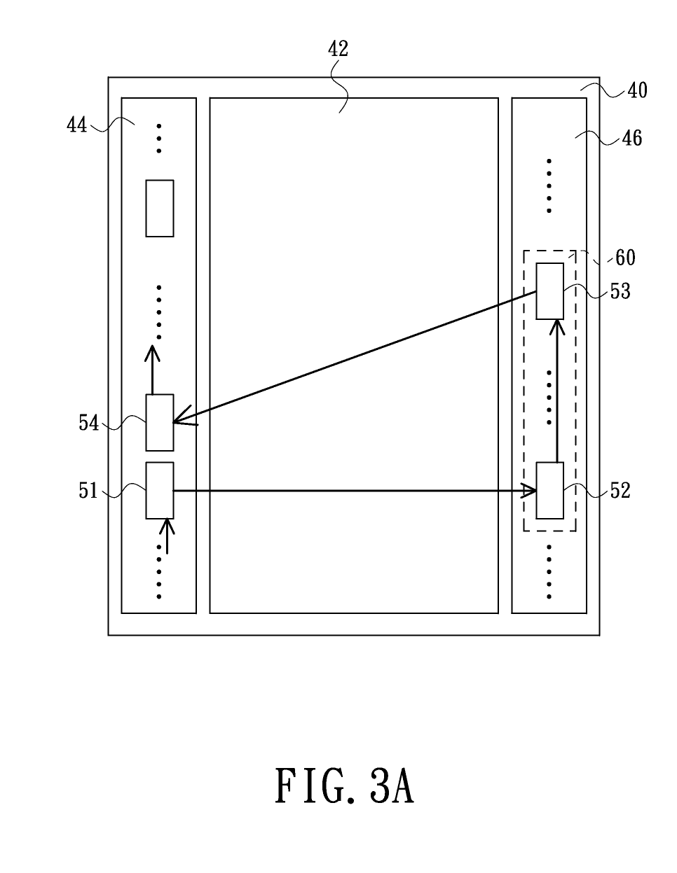

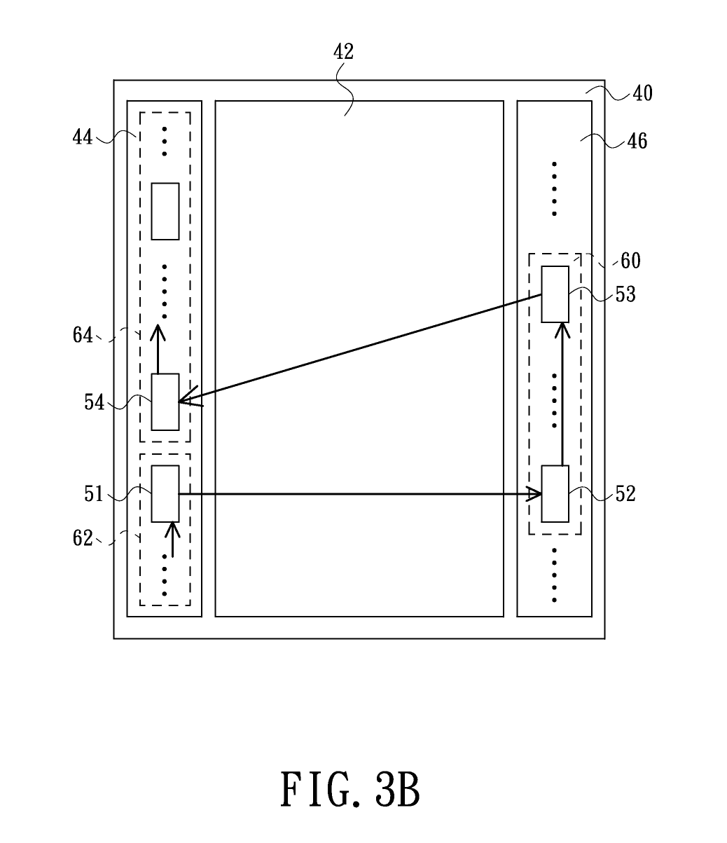

FIG. 3A is a diagram that schematically depicts a driving signal sequentially transmitted in N gate driver modules coupled in series in a display panel structure according to a present disclosure. As depicted in FIG. 3A, the display panel 40 comprises a pixel array 42, a first gate driver circuit 44 and a second gate driver circuit 46. Moreover, N gate driver modules are allocated to the first gate driver circuit 44 and the second gate driver circuit 46, wherein a first gate driver module 51 and a fourth gate driver module 54 are arranged in the first gate driver circuit 44 and a first gate driver module set 60 is arranged in the second gate driver circuit 46, as depicted in FIG. 3A. The first gate driver module set 60 comprises at least two gate driver modules; wherein a second gate driver module 52 is the first gate driver module and a third gate driver module 53 is the last gate driver module in the first gate driver module set 60. Moreover, the output terminal of the first gate driver module 51 is electrically coupled to the second gate driver module 52; and the output terminal of the third gate driver module 53 is electrically coupled to the fourth gate driver module 54. Moreover, the multiple gate driver modules of the first gate driver module set 60 are coupled in series and the driving signal is transmitted sequentially in the multiple gate driver modules. As depicted in FIG. 3A, the driving signal is transmitted sequentially from the first gate driver module 51 via the second gate driver module 52, the multiple gate driver modules arranged between the second gate driver module 52 and the third gate driver module 53, and the third gate driver module 53, to the fourth gate driver module 54. As depicted in FIG. 3B, it is noted that the first gate driver circuit 44 also includes at least two gate driver module sets, a second gate driver module set 62 and a third gate driver module set 64, having multiple gate driver modules coupled in series, herein, the first gate driver module 51 is arranged in the second gate driver module set 62 and the fourth gate driver module 54 is arranged in the third gate driver module set 64.

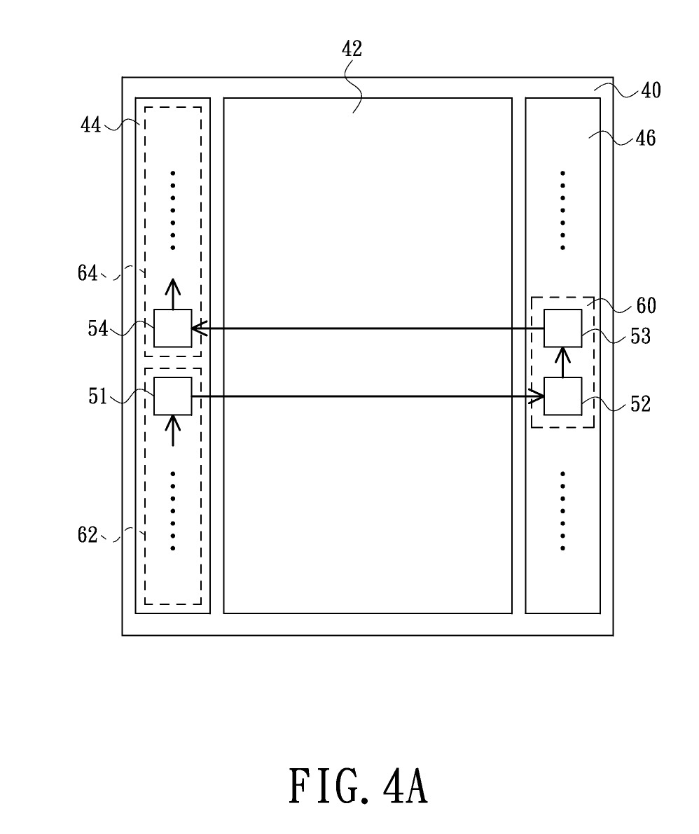

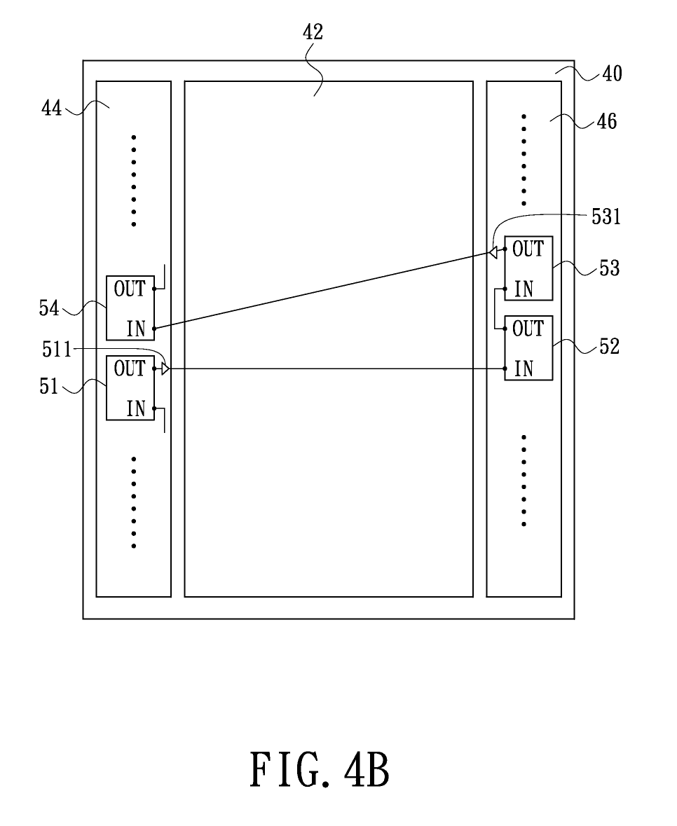

FIG. 4A is a diagram that schematically depicts the driving signal sequentially transmitted in the N gate driver modules coupled in series in the display panel structure in one embodiment. As depicted in FIG. 4A, the first gate driver module set 60 comprises the second gate driver module 52 and the third gate driver module 53; wherein the output terminal of the first gate driver module 51 is electrically coupled to the second gate driver module 52, the output terminal of the third gate driver module 53 is electrically coupled to the fourth gate driver module 54. As depicted in FIG. 4A, the driving signal is transmitted sequentially from the first gate driver module 51 via the second gate driver module 52 and the third gate driver module 53, to the fourth gate driver module 54. As mentioned above, the first gate driver circuit 44 includes the second gate driver module set 62 and the third gate driver module set 64, and the first gate driver module 51 is arranged in the second gate driver module set 62 and the fourth gate driver module 54 is arranged in the third gate driver module set 64.

FIG. 4B is a circuit diagram that schematically depicts the display panel structure in accordance with the one embodiment having an arrangement of placing the N gate driver modules on the two sides of the pixel array. As depicted in FIG. 4B, the output terminal OUT of the first gate driver module 51 is electrically coupled to the input terminal IN of the next-stage second gate driver module 52; the output terminal OUT of the second gate driver module 52 is electrically coupled to the input terminal IN of the next-stage third gate driver module 53; the output terminal OUT of the third gate driver module 53 is electrically coupled to the input terminal IN of the next-stage fourth gate driver module 54. Moreover, the first gate driver module 51 and the fourth gate driver module 54 are arranged in the first gate driver circuit 44; and the second gate driver module 52 and the third gate driver module 53 are arranged in the second gate driver circuit 46. As depicted in FIG. 4B, the driving signal is transmitted from the input terminal IN of the first gate driver module 51 sequentially via the output terminal OUT of the first gate driver module 51, the input terminal IN of the second gate driver module 52, the output terminal OUT of the second gate driver module 52, the input terminal IN of the third gate driver module 53, and the output terminal OUT of the third gate driver module 53, to the input terminal IN of the fourth gate driver module 54.

As depicted in FIG. 4B, for enhancing the strength of the driving signal, a first buffer 511 is arranged between the first gate driver module 51 and the second gate driver module 52 and for receiving and storing the driving signal from the first gate driver module 51 and then further transmitting the driving signal to the second gate driver module 52. The first buffer 511 is arranged at the output terminal OUT of the first gate driver module 51 in accordance with the embodiment; however, it is understood that the first buffer 511 may be arranged at other specific positions, such as positions near the first gate driver module 51 or the second gate driver module 52 or on the pixel array region 42, based on design considerations.

Similarly, as depicted in FIG. 4B, a second buffer 531 is also arranged between the third gate driver module 53 and the fourth gate driver module 54 and for receiving and storing the driving signal from the third gate driver module 53 and then further transmitting the driving signal to the fourth gate driver module 54. The second buffer 531 is arranged at the output terminal OUT of the third gate driver module 53 in accordance with the embodiment; however, it is understood that the second buffer 531 may be arranged at other specific positions, such as positions near the third gate driver module 53 or the fourth gate driver module 54 or on the pixel array region 42, based on other considerations.

To sum up, because the multiple gate driver modules are arranged on the both sides of the pixel array in the disclosure, the unit width of each of the multiple gate driver modules can be flexibly adjusted to smaller so as the border of the display panel is slimmer.

While the disclosure has been described in terms of what is presently considered to be the most practical and embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An arrangement method, applied to a plurality of gate driver modules coupled in series and arranged on two sides of a panel, comprising steps of:
placing a first gate driver module on a first side of the panel;
placing a gate driver set on a second side of the panel, wherein the gate driver set comprises a second gate driver module and a third gate driver module serially connected; and
placing a fourth gate driver module on the first side of the panel;
wherein the output terminal of the first gate driver module is electrically coupled to the second gate driver module and the output terminal of the third gate driver module is electrically coupled to the fourth gate driver module.

2. A gate driver circuit of a panel, comprising:
a first gate driver module, arranged on a first side of the panel, for outputting a driving signal;
a first gate driver module set, arranged on a second side of the panel and electrically coupled to the first gate driver module, wherein the first gate driver module set comprises a plurality of gate driver modules coupled in series; and
a fourth gate driver module, arranged on the first side of the panel and electrically coupled to the gate driver module set, for receiving the driving signal from the first gate driver module set and then further transmitting the driving signal.

3. The gate driver circuit according to claim 2, wherein a second gate driver module is the first one gate driver module and a third gate driver module is the last one gate driver module in the first gate driver module set, the second gate driver module is electrically coupled to the first gate driver module for receiving the driving signal from the first gate driver module, the third gate driver module is electrically coupled to the fourth gate driver module for transmitting the driving signal to the fourth gate driver module.

4. The gate driver circuit according to claim 3, further comprising:
a first buffer unit, arranged on the first side of the panel and electrically coupled between the first gate driver module and the second gate driver module, for receiving and storing the driving signal from the first gate driver module and then further transmitting the driving signal to the second gate driver module.

5. The gate driver circuit according to claim 3, further comprising:
a second buffer unit, arranged on the second side of the panel and electrically coupled between the third gate driver module and the fourth gate driver module, for receiving and storing the driving signal from the third gate driver module and then further transmitting the driving signal to the fourth gate driver module.

6. The gate driver circuit according to claim 2, further comprising:
a second gate driver module set, arranged on the first side of the panel and electrically coupled to the first gate driver module set, wherein the second gate driver module set comprises a plurality of gate driver modules coupled in series and the first gate driver module is the last one gate driver module in the second gate driver module set.

7. The gate driver circuit according to claim 2, further comprising:
a third gate driver module set, arranged on the first side of the panel and electrically coupled to the first gate driver module set, wherein the third gate driver module set comprises a plurality of gate driver modules coupled in series and the fourth gate driver module is the first one gate driver module in the third gate driver module set.

8. An arrangement method, applied to a plurality of shift register sets coupled in series and arranged on two sides of a panel, comprising steps of:
placing a first shift register set and a second shift register set on a first side of the panel; and
placing a third shift register set on a second side of the panel;
wherein each of the first, the second, and the third shift register set comprises a plurality of shift registers, the shift registers in the first shift register set are coupled in series, the shift registers in the second shift register set are coupled in series, and the shift registers in the third shift register set are coupled in series;
wherein the output terminal of the last shift register in the first shift register set is electrically coupled to the first shift register in the third shift register set, and the output terminal of the last shift register in the third shift register set is electrically coupled to the first shift register in the second shift register set.
